(19) United States
(12) Patent Application Publication
(10) Pub. No.: US 2011/0149561 A1
(43) Pub. Date: Jun. 23, 2011

(54) RADIATION SHIELDED SYRINGE

(76) Inventor: Chi-Kuang Chen, Taipei City (TW)

(21) Appl. No.: 12/640,729

(22) Filed: Dec. 17, 2009

(51) Int. Cl. F21L 4/00

(52) U.S. Cl. 362/191; 362/190

(57) ABSTRACT

A radiation shielded syringe includes primarily an outer shell, a power supply socket and an illuminating element. An interior of the outer shell defines a holding space to accommodate the syringe, a side of the outer shell defines a piece of glass (lead glass) through which medicine in the syringe can be clearly observed, and an inner wall of the outer shell defines a groove for putting the illuminating element. An end of the outer shell defines a seat which is assembled with the power supply socket and the power supply socket is electrically connected with the illuminating element. When observing a dosage of the medicine, the illuminating element is activated and the dosage is observed through the glass. Therefore, the radiation shielded syringe enables the dosage to be effectively, conveniently and clearly observed and is equipped with a radiation protection function at a same time.

### BACKGROUND OF THE INVENTION

a) Field of the Invention

The present invention relates to a radiation shielded syringe, and more particularly to a radiation shielded syringe, with a dosage of medicine in the syringe being able to be observed clearly through a light source.

b) Description of the Prior Art

A dosage of medicine is very critical in injection, as the dosage will determine health of a person. Conventionally, when dispensing the dosage of medicine, a third object should be used for illumination and a light source which illuminates should beam correspondingly with the dosage that the dosage can be clearly observed. As a result, an angle of the light source has to be adjusted all the time. This adjustment is very troublesome and is always under high radiation. Therefore, the existing technique for observing and measuring the dosage should be improved to save time and cost, and to protect health.

Accordingly, how to solve the aforementioned problems and shortcomings of the prior art is a direction of research and development for improvement by the present inventor and related vendors.

### SUMMARY OF THE INVENTION

The primary object of the present invention is to provide a radiation shielded syringe which includes an outer shell, an interior of which defines a holding space to accommodate the syringe, a side of which defines a piece of glass, an inner wall of which defines a groove and an end of which defines a seat. The seat is provided with a perforation for transfixing with the syringe and is assembled with a power supply socket, an interior of which is accommodated with a battery unit. The power supply socket is electrically connected with an illuminating element which is provided in the aforementioned groove. Moreover, two sides of the outer shell are transfixed respectively with a clamp element to clamp and fix the aforementioned syringe and an end of the power supply socket defines a cover on which is further provided with a pull ring, facilitating a user to take out the cover. Therefore, when the user is to observe the medicine in the syringe, the illuminating element can operate through power supply of the battery unit; after the illuminating element has operated, the holding space can be illuminated, allowing the user to clearly observe the dosage of medicine in the holding space by that piece of glass. By the aforementioned technologies, the problems existing in the conventional syringe that when dispensing the dosage of medicine, a third object should be used for illumination and a light source which illuminates should beam correspondingly with the dosage that the dosage can be clearly observed, so that an angle of the light source has to be adjusted all the time, which is very troublesome, can be solved, allowing the dosage to be clearly observed through assembling the illuminating element with the power supply socket without using the third object for illumination, thereby effectively improving speed and time.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows an exploded view of the preferred embodiment of the present invention.

FIG. 3 shows a first schematic view of an operation of the preferred embodiment of the present invention.

FIG. 4 shows a second schematic view of the operation of the preferred embodiment of the present invention.

FIG. 5 shows a third schematic view of the operation of the preferred embodiment of the present invention.

FIG. 6 shows a fourth schematic view of the operation of the preferred embodiment of the present invention.

### DETAILED DESCRIPTION OF THE PREFERRED EMBODIMENTS

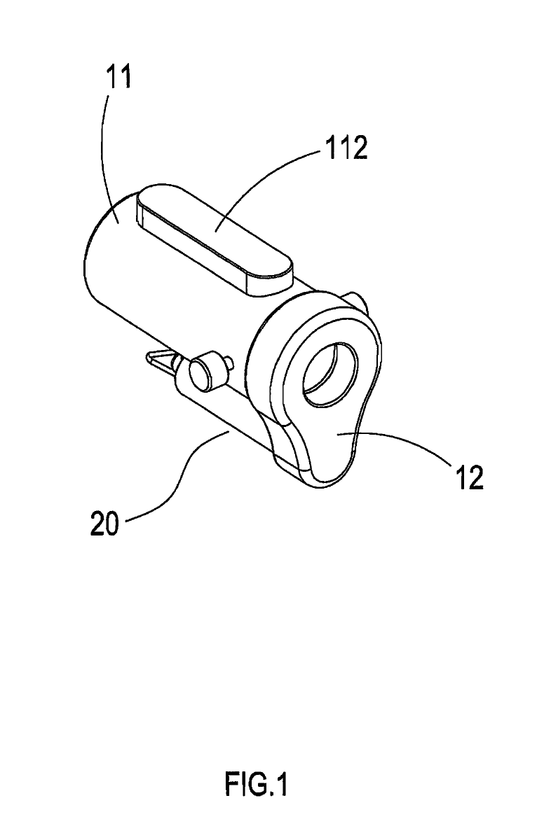

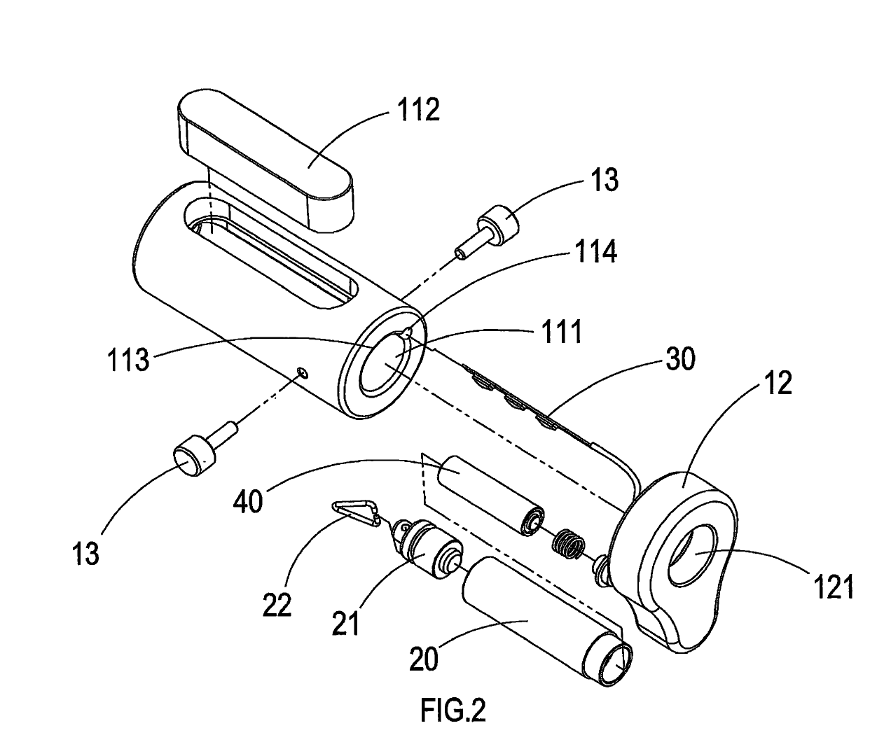

Referring to FIG. 1 and FIG. 2, it shows a three-dimensional view and an exploded view of a preferred embodiment of the present invention. As shown in the drawings, the present invention comprises an outer shell 11 and a power supply socket 20.

An interior of the outer shell 11 defines a holding space 111 to accommodate the syringe, a side of the outer shell 11 defines a piece of glass 112 to clearly observe medicine in the syringe, and the glass 112 can be lead glass. In addition, an inner wall 113 of the outer shell 11 defines a groove 114 and an end of the outer shell 11 defines a seat 12 which is provided with a perforation 121 for transfixing with the syringe. Moreover, two sides of the outer shell 11 are transfixed respectively with a clamp element 13 to fix the syringe and the inner wall 113 of the outer shell 11 further defines a layer of white baked-enamel coating to increase a backlit effect.

The power supply socket 20 is assembled with the seat 12 and is electrically connected with an illuminating element 30 which is provided in the aforementioned groove 114, wherein the illuminating element 30 can be an LED (Light Emitting Diode) lamp. Moreover, an end of the power supply socket 20 define a cover 21 on which is further provided with a pull ring 22 and an interior of the power supply socket 20 is accommodated with a battery unit 40.

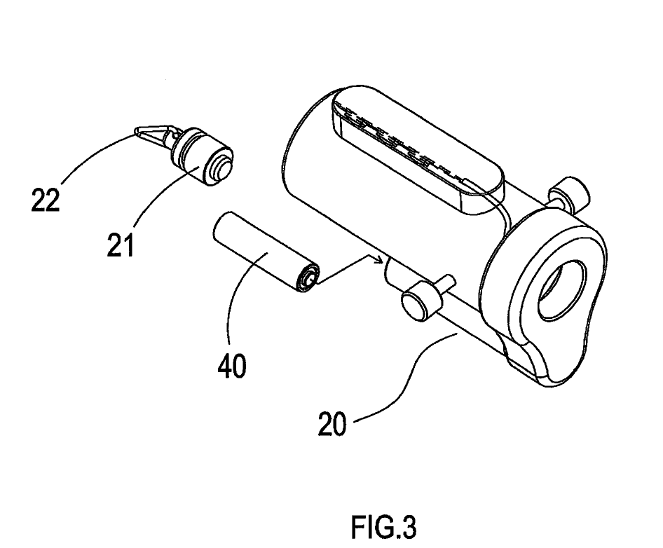

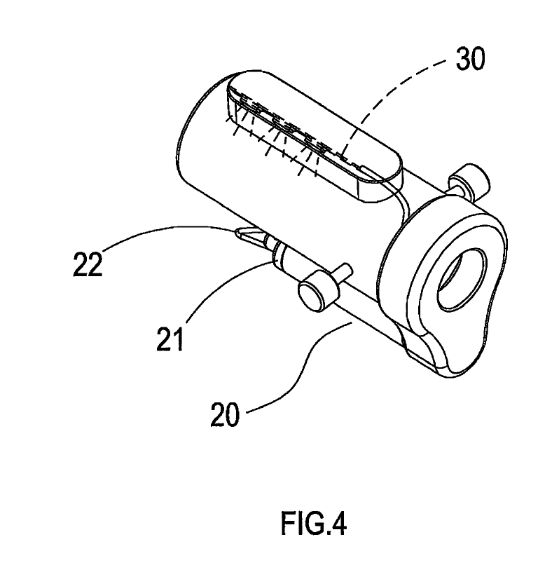

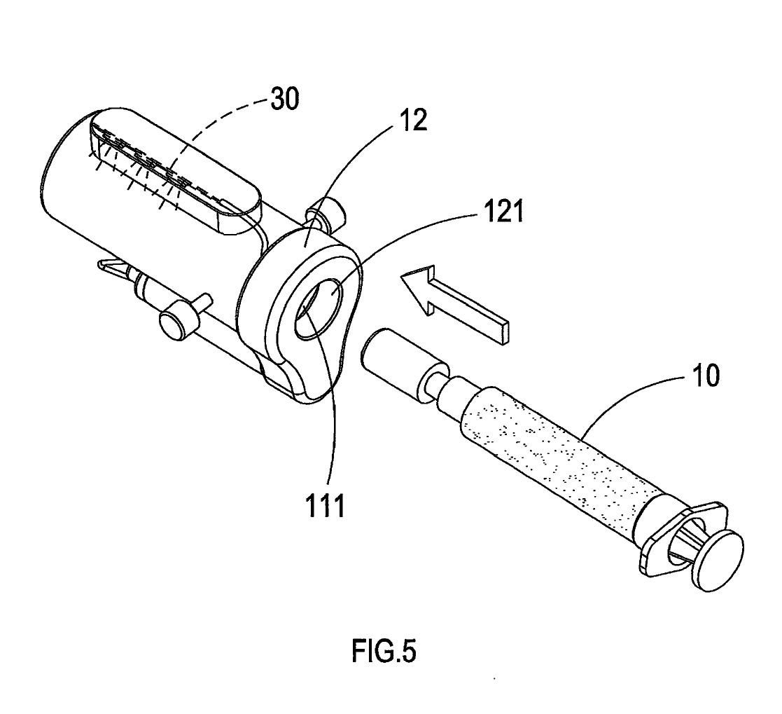

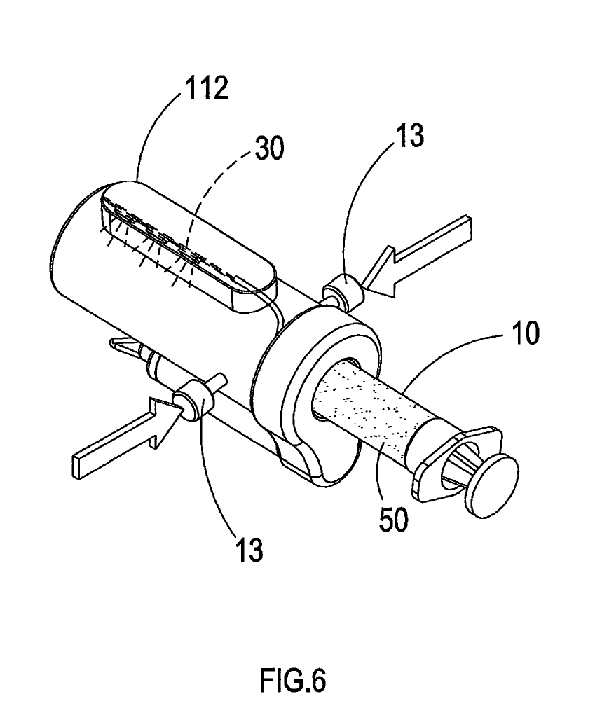

Referring to FIGS. 2, 3, 4, 5 and 6, it shows the exploded view, a first schematic view of an operation, a second schematic view of the operation, a third schematic view of the operation and a fourth schematic view of the operation, of the preferred embodiment of the present invention. As shown in the drawings, the present invention comprises primarily the outer shell 11, the power supply socket 20 and the illuminating element 30, wherein the interior of the outer shell 11 defines the holding space 111 to accommodate a syringe 10, one side of the outer shell 11 defines the glass 112 (lead glass) through which medicine 50 in the syringe 10 can be clearly observed, the inner wall 113 of the outer shell 11 defines the groove 114 for putting the illuminating element 30, and one end of the outer shell 11 defines the seat 12 which is assembled with the power supply socket 20. The power supply socket 20 is electrically connected with the illuminating element 30 which can be an LED. In addition, two sides of the outer shell 11 are transfixed respectively with the clamp element 13 to fix the syringe 10 and one end of the power supply socket 20 defines the cover 21 on which is further provided with the pull ring 22 to facilitate the user to take out the cover 21; whereas, the power supply socket 20 contains the battery unit 40. As a result, when the user is to use the syringe 10, he or she can take out the cover 21 through the pull ring 22, put the battery unit 40 into the power supply socket 20, cover with the cover 21 and then put the syringe 10 in the holding space 111 by transfixing the syringe 10 into the perforation 121 of the seat 12. In a mean time, the syringe 10 is clamped and fixed at two sides by the clamp elements 13. After the aforementioned steps, the user can activate the illuminating element 30 to clearly illuminate the medicine 50 when the illuminating element 30 illuminates; whereas, the user can also observe the dosage of medicine 50 through the glass 112. Therefore, the present invention is provided with a high efficiency, saves a lot of time and protects from radiation.

Accordingly, referring to all the drawings, the present invention is actually provided with following advantages in comparison with the prior art.

By assembling the illuminating element 30 with the power supply socket 20, the medicine 50 in the holding space 111 can be illuminated clearly and the dosage of medicine 50 can be clearly observed without requiring the third object for illumination, thereby effectively improving the speed and time.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A radiation shielded syringe comprising:
an outer shell, an interior which defines a holding space to accommodate the syringe, a side of the outer shell defines a piece of glass to clearly observe medicine in the syringe, an inner wall of the outer shell defines a groove and an end of the outer shell defines a seat, with the seat being provided with a perforation for transfixing with the syringe; and
a power supply socket which is assembled with the seat and is electrically connected with an illuminating element being provided in the groove.

2. The radiation shielded syringe according to claim 1, wherein the glass is lead glass.

3. The radiation shielded syringe according to claim 1, wherein two sides of the outer shell are transfixed respectively with a clamp element.

4. The radiation shielded syringe according to claim 1, wherein the illuminating element is an LED (Light Emitting Diode) lamp.

5. The radiation shielded syringe according to claim 1, wherein an end of the power supply socket defines a cover on which is further provided with a pull ring.

6. The radiation shielded syringe according to claim 1, wherein the power supply socket accommodates a battery unit.

7. The radiation shielded syringe according to claim 1, wherein the inner wall of the outer shell further defines a layer of white baked-enamel coating to increase a backlit effect.
